(19) United States
(12) Patent Application Publication
(10) Pub. No.: US 2007/0139588 A1
(43) Pub. Date: Jun. 21, 2007

(54) COLOR FILTER SUBSTRATE, LIQUID CRYSTAL DISPLAY DEVICE, ELECTRONIC APPARATUS, AND METHODS FOR MANUFACTURING COLOR FILTER SUBSTRATE AND LIQUID CRYSTAL DISPLAY DEVICE

(75) Inventors: Toshiyuki Nonaka, Suwa (JP); Shoichi Yamadera, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 11/610,536

(22) Filed: Dec. 14, 2006

(30) Foreign Application Priority Data
Dec. 19, 2005 (JP) 2005-364471

(51) Int. Cl. G02F 1/1335

(52) U.S. Cl. 349/106

(57) ABSTRACT

A color filter substrate includes: a first partition wall for partitioning a substrate into a plurality of color element regions; a second partition wall for dividing each of the plurality of color element regions into a plurality of regions; color elements having a plurality of types, being formed on the plurality of color element regions; a transparent electrode covering the first partition wall, the second partition wall, and the color element; and a projection or an aperture formed on the transparent electrode; wherein the second partition wall is arranged in the direction in which the projection or the aperture is extended.

### BACKGROUND

1. Technical Field

The present invention relates to a color filter substrate, color elements thereof being formed using droplet discharge method, a liquid crystal display device and electronic apparatus including the color filter substrate, and a method for manufacturing the color filter substrate and the liquid crystal display device.

2. Related Art

The color filters currently known and used as a color filter substrate for liquid crystal displays, have projections formed on a common transparent electrode that covers colored layers, with the projections having relative permittivity of 11 or less, and an electric conductivity of 3*10¹² S/cm or more (refer to JP-A-2003-35905, page 4-5). According to related art, the colored layers on which the projections are arranged can be formed by pigment dispersion using a photosensitive resin containing the desired coloring material, or by other methods such as printing, electro deposition, and transfer.

Further, the projections can be formed with photolithography, using negative or positive photosensitive resin containing conductive powders within the composition thereof.

Liquid crystal display devices having such color filters, operated in multi-domain vertical alignment (MVA) mode, is said to have less ion bias within a liquid crystal cell, and reduced image persistence caused by the accumulation of charge in the boundary face between an orientation film and liquid crystals.

As for a method for manufacturing color filters having multiple types of colored layers (color elements) on a substrate, the inkjet method (as one of the droplet discharge method) is known for forming the colored layers first forming on the substrate a plurality of coloring parts (color element regions) that are surrounded by partition walls, thereafter discharging the coloring ink to the coloring parts, followed by drying the coloring ink in a pre-set temperature (refer to JP-A-2003-66222, page 2-3).

In recent years, liquid crystal display devices in MVA mode are employed for colored televisions, and the sizes of those screens are increasingly getting larger This causes the size increase of the color filter substrate being used, resulting in a problem of requiring many complex processing steps, such as substrate coating with photosensitive resin, exposure, development and washing, as well as extensive equipments compliant with larger-sized substrates, in order to form, using photolithography, the colored layers or projections for orientation control.

Moreover, in the color filters mentioned above, projections for controlling orientation are formed on the deposited colored layers, resulting in a problem that the materials used in forming the colored layers are consumed in a high wastage, since the colored layer under the projections are not effective for actual display.

In order to solve the above problems, the inkjet method may be used for forming the colored layers. However, in this technique, a phenomenon called “clear defect” occurs, since it is difficult to pervade coloring inks throughout the corners of pixels, as the pixel size increases in the liquid crystal display device, causing the frequency increase of the coloring inks discharge onto the coloring parts that correspond to the pixels. The above inkjet method also involves a problem that it is difficult to assure the flatness of the surface of the colored layers.

### SUMMARY

An advantage of the invention is to provide a color filter substrate, a liquid crystal display device and electronic apparatus, as well as methods for manufacturing the color filter substrate and the liquid crystal display device, where the color filter substrate is provided with color elements having a uniform quality in the color element regions, while allowing to reduce the wastage of the color element forming material.

According to a first aspect of the invention, a color filter substrate includes: a first partition wall for partitioning a substrate into a plurality of color element regions; a second partition wall for dividing each of the plurality of color element regions into a plurality of regions; color elements having a plurality of types, being formed on the plurality of color element regions; a transparent electrode covering the first partition wall, the second partition wall, and the color element; and a projection or an aperture formed on the transparent electrode; wherein the second partition wall is arranged in the direction in which the projection or the aperture is extended.

In the above color filter substrate, the second partition wall is formed so as to divide the color element regions partitioned by the first partition wall into a plurality of regions. Therefore, compared to the case without the second partition wall, it is easier to flatten the color elements being formed, since those color elements are formed per plurality of regions, each having smaller area size as a result of dividing the color element regions. The second partition wall has little affect on display, particularly in the color filter substrates used for a large-sized liquid crystal display device, even in the case of dividing the color element region into the plurality of regions with the second partition wall, since the size of the color element region corresponding to a display pixel is large. Moreover, the second partition wall is arranged in the direction, in which the projection or the aperture, formed on the transparent electrode is extended. As a result, the color elements are not arranged under the projections or apertures that do not contribute to the display, in contrast to the case where the projections or apertures for orientation control are formed on the transparent electrode covering the color elements. That is to say, it is possible to reduce the wastage of the color element forming material, and the color filter substrate having the color elements with a uniform quality are provided in the color element regions.

It is desirable that those color elements be formed by discharging functional fluids containing color element forming materials, to the color element regions. Here, the color element regions are partitioned by the first partition wall, and they are further divided into the plurality of regions by the second partition wall. This allows the color elements to have uniform film thickness and flatness, since the functional fluid containing the color element forming material is discharged and pervaded to the color element regions per plurality of regions, each of which having a smaller area after being divided. That is to say, it is possible reduce clear defects, in which the color elements are not formed in some part of the color element regions, providing the color filter substrate having the color elements with a uniform quality in the color element regions.

It is desirable that the above-referenced color elements to have an approximately the same film thickness as that of the first partition wall and the second partition wall. When an orientation film is formed covering the substrate surface, so as to orient the liquid crystals in an approximately vertical direction, the above structure allows the color element regions to be divided into the plurality of orientation-controlled regions having the second partition wall as a boarder, without causing irregularity in liquid crystal orientation at the boundary between the color element and the first partition wall or the second partition wall.

According to a second aspect of the invention, a liquid crystal display device includes, the color filter substrate according the first aspect of the invention; a counter substrate having a plurality of pixel electrodes corresponding to the plurality of color element regions on the color filter substrate; and liquid crystals sandwiched by the color filter substrate and the counter substrate; wherein an orientation film is provided to surfaces which contact the liquid crystals, the orientation film orienting molecules of liquid crystals in a direction approximately vertical to the surfaces of the color filter substrate and of the counter substrate.

This allows a wastage reduction of the color element forming material. This also provides a MVA mode liquid crystal display device, having the color filter substrate with the color elements of uniform quality in the color element regions, which provides high cost-performance and high display quality with less display defects such as clear defects and color irregularity.

According to the second aspect of the invention, an aperture is provided on the above-referenced pixel electrodes, at locations corresponding to the plurality of regions divided by the second partition wall, the aperture opening toward the color filter substrate extending in parallel to the second partition wall.

The viewing angle property depends on the orientation status of the liquid crystal molecules during activation. In the above, the molecules of the liquid crystal shift, inclining to the direction of the aperture provided in the pixel electrode, when a drive voltage is impressed, having the orientation-controlling projection or the aperture located on the second partition wall as a border. Consequently, the MVA mode liquid crystal display device with a wide viewing angle is provided, as the plurality of orientation-controlled regions is formed in a display region where the pixel electrodes are installed, those regions having different viewing angle properties separated by the second partition wall.

An electronic device, according to a third aspect of the invention, is mounted with the above-referenced liquid crystal display device. Such electronic device, mounted with a high-quality MVA mode liquid crystal display device, has excellent display quality, and high performance and competitiveness in cost.

According to a forth aspect of the invention, a method for manufacturing a color filter substrate includes: a partition wall forming process for forming a first partition wall and a second partition wall on a substrate, a plurality of color element regions partitioned by the first partition wall, and the second partition wall dividing each of the plurality of color element regions into a plurality of regions; a color element forming process for forming color elements having a plurality of variations, by discharging a plurality of functional fluids containing different color element forming materials, to the color element regions; an electrode forming process for forming a transparent electrode covering the first partition wall, the second partition wall, and the color element; and a process for forming a projection or an aperture formed on the transparent electrode; wherein, in the partition wall forming process, the second partition wall is arranged in the direction in which the projection or the aperture is extended.

With the above method, in the partition wall forming process, the first partition wall is formed so that the plurality of color element regions are partitioned thereby, and at the same time, the second partition wall are formed so as to divide each of the plurality of color element regions into the plurality of regions. In the color element forming process, the color elements with plurality of types are formed, by discharging the plurality of functional fluids containing different color element forming materials to the color element regions. Consequently, the color elements having a uniform quality can be formed, since the functional fluid is discharged and pervaded to the color element regions per aforementioned plurality of regions, each of which having a smaller area size after being divided by the second partition wall. Moreover, the second partition wall is arranged in the direction in which the projection or the aperture that is formed on the transparent electrode is extended. As a result, the color elements are not formed under the projections or apertures that do not contribute to the display, in contrast to the case where the projections or apertures for orientation control is formed on the transparent electrode covering the color elements. Consequently, the wastage of the color element forming material as well as defects such as clear defects are reduced, allowing the manufacturing of color filter substrates having color elements with a uniform quality, in a high yield Such method for manufacturing the color filter substrate is particularly suitable for the color filter substrates having large-sized pixels (or color element regions) used in MVA mode liquid crystal display devices.

In the above-referenced color element forming process, it is desirable to discharge the functional fluid, so that the color elements have an approximately the same film thickness as that of the first partition wall and the second partition wall. This reduces the occurrences where the first partition wall, the second partition wall, and the color elements are not level. If the orientation film is formed on the surface of such color filter substrate manufactured using the above method, it is possible to manufacture the color filter substrate that is less likely to have orientation irregularity caused by the asperity on the orientation film surface.

In the above-referenced aspects of the invention, it is desirable to further include a surface treatment process for providing liquid repellency to surfaces including at least vertices of the first partition wall and the second partition wall.

The above-referenced method allows the functional fluid to be placed within the color element regions without wastage during the color element forming process, since the functional fluid that landed on the first partition wall and the second partition wall is repelled by the liquid repellency treatment process.

The method for manufacturing the color filter substrate may further include: a liquid repellency treatment process for providing liquid repellency to a surface of the substrate; and a lyophilic treatment process for providing a lyophilic property to the liquid repellent surface of the substrate corresponding to the regions for forming the first partition wall and the second partition wall; wherein, in the partition wall forming process, the first partition wall and the second partition wall are formed by discharging a functional fluid containing a partition wall forming material to the lyophilic surface of the substrate.

In the above referenced method, the liquid repellency is provided in advance to the surface of the substrate in the liquid repellency treatment process, and the lyophilic property is provided to the regions for forming the first partition wall and the second partition wall in the lyophilic treatment process. Thereafter, in the partition wall forming process, the discharged functional fluid containing the partition wall forming material spreads out to the lyophilic surface of the substrate, while it does not spread out on the surface that underwent the liquid repellent treatment. Hence, the first partition wall and the second partition wall can be formed in the same step where the color element regions are partitioned by the first partition wall and the second partition wall divides the color element into the plurality of regions. Moreover, compared to the case of forming the first partition wall and the second partition wall by photolithography, the color filter substrate is manufactured in more simplified manufacturing process, since the photomask, as well as steps such as exposure, development, and washing are not required.

The method for manufacturing the color filter substrate may still further include: a liquid repellency treatment process for providing liquid repellency to a surface of the substrate on which the first partition wall is formed; and a lyophilic treatment process for providing the lyophilic property to a liquid repellent surface of the substrate corresponding to the region for forming the second partition wall; wherein, when forming the second partition wall, the second partition wall is formed by discharging a functional fluid containing a partition wall forming material to the lyophilic surface of the substrate.

According to the above method, in the partition wall forming process, the liquid repellent treatment is carried out after forming the first partition wall on the substrate surface, while the second partition wall is formed by discharging the functional fluid on the lyophilic surface of the substrate. This means that the color element region can be partitioned in more consistent manner, if the first partition wall and the second partition wall are formed in the separate steps, and the first partition wall is formed, for instance, with photolithography. Moreover, modifications in locations for forming the projections or apertures can be accommodated without modifying the photomask, since the second partition wall is formed by discharging the functional fluid on the substrate surface that underwent lyophilic treatment.

In the above-referenced lyophilic treatment process, it is preferable that the lyophilic property is provided to a liquid repellent surface including at least the region corresponding to where the second partition wall is to be formed, by irradiating a light thereon. This allows a lyophilic property to be provided to the region for forming the second partition wall in a high precision, since the light is irradiated as a method to provide lyophilic property on the substrate surface that underwent the liquid repellency treatment.

It is preferable that: a thin film having liquid repellency be formed on the surface of the substrate in the above-referenced liquid repellency treatment process; and the thin film remaining at least on the color element regions be removed in the color element forming process. This allows the functional fluid containing the color element formation material to spread out more easily upon its landing, since the thin film remaining in the color element formation regions are removed in the color element forming process that includes the step for removing the liquid repellent thin film. Consequently, the color elements with a uniform quality can be formed by pervading the functional fluid throughout the color element regions.

According to a fifth aspect of the invention, a method for manufacturing a liquid crystal display device includes: forming a color filter substrate, using the method for manufacturing the color filter substrate according to the forth aspect of the invention; wherein the liquid crystal display device includes: the color filter substrate having color elements having a plurality of types; a counter substrate having a plurality of pixel electrodes corresponding to the color elements provided with a plurality of types liquid crystals sandwiched by the color filter substrate and the counter substrate, and an orientation film, provided to surfaces which contact the liquid crystals, orienting molecules of liquid crystals in a direction approximately vertical to the surfaces of the color filter substrate and of the counter substrate.

With this method, the second partition wall that divides the color region into the plurality of regions is arranged at a location corresponding to the direction in which the orientation-controlling projection or aperture is extended. Consequently, using the color filter substrate manufacturing method in which the wastage of the color element forming material is reduced and color elements with a uniform quality are formed, the color filter substrate that comprises the liquid crystal display device is manufactured. This allows manufacturing of the MVA mode liquid crystal display device with reduced defects such as clear defects and color irregularity, in a high yield at low cost.

### BRIEF DESCRIPTION OF THE DRAWINGS

The invention will be described with reference to the accompanying drawings, wherein like numbers reference like elements.

FIG. 1 is a schematic top view drawing showing a structure of a color filter substrate according to a first embodiment.

FIG. 2 is a magnified top view drawing showing color element regions.

FIG. 3 is a schematic sectional drawing of the color filter substrate, cut along a section A-A line shown in FIG. 2.

FIG. 4 is a flow chart showing a method for manufacturing the 1; color filter substrate according to the first embodiment.

FIGS. 5A to 5E are schematic sectional drawings showing the method for manufacturing the color filter substrate.

FIG. 6 is a schematic sectional drawing showing the structure of a liquid crystal display device according to the first embodiment.

FIG. 7 is a magnified top view drawing showing a pixel.

FIG. 8 is a magnified top view drawing showing color element regions of a color filter substrate according to a second embodiment.

FIG. 9 is a schematic sectional drawing of the color filter substrate, cut along a section C-C line shown in FIG. 3.

FIG. 10 is a flow chart showing a method for manufacturing the color filter substrate according to the second embodiment.

FIGS. 11A to 11H are schematic sectional drawings showing the method for manufacturing the color filter substrate.

FIG. 12 is a schematic sectional drawing showing the structure of a liquid crystal display device according to the second embodiment.

FIG. 13 is a magnified top view drawing showing the pixel.

FIG. 14 is a schematic oblique drawing showing a large-sized liquid crystal television as an electronic apparatus.

FIGS. 15A to 15F are schematic sectional drawings showing the method for manufacturing the color filter substrate according to modifications.

FIGS. 16A and 16B are top view drawings showing an arrangement of the color elements according to modifications.

### DESCRIPTION OF EXEMPLARY EMBODIMENTS

Embodiments of the present invention will now be described referring to examples such as: a color filter substrate having an orientation film for vertical orientation; and a MVA mode liquid crystal display device that uses the color filter substrate. Drawings used for explanation are arbitrarily magnified or scaled down, in order to clarity the constituting elements

### First Embodiment

Color Filter Substrate

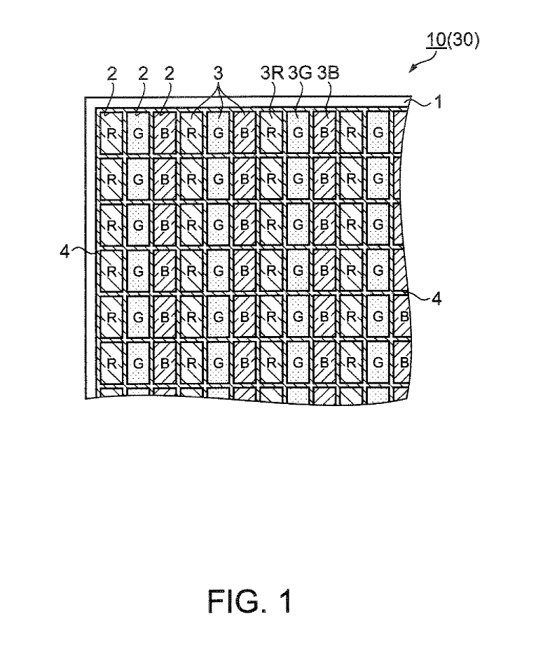

FIG. 1 is a schematic top view drawing showing a structure of a color filter substrate according to a first embodiment. As shown in FIG. 1, a color filter substrate 10 according to the first embodiment includes first partition walls 4 for partitioning a transparent glass substrate 1 (i.e. a substrate) into the plurality of color elements regions 2. Color elements 3 having three colors of red, green and blue (RGB) are formed in each of the color element regions 2. Color elements 3R, 3G, and 3B are arranged, so that color elements of the same color are arranged linearly In other words, the color filter substrate 10 has color elements 3 aligned in stripes.

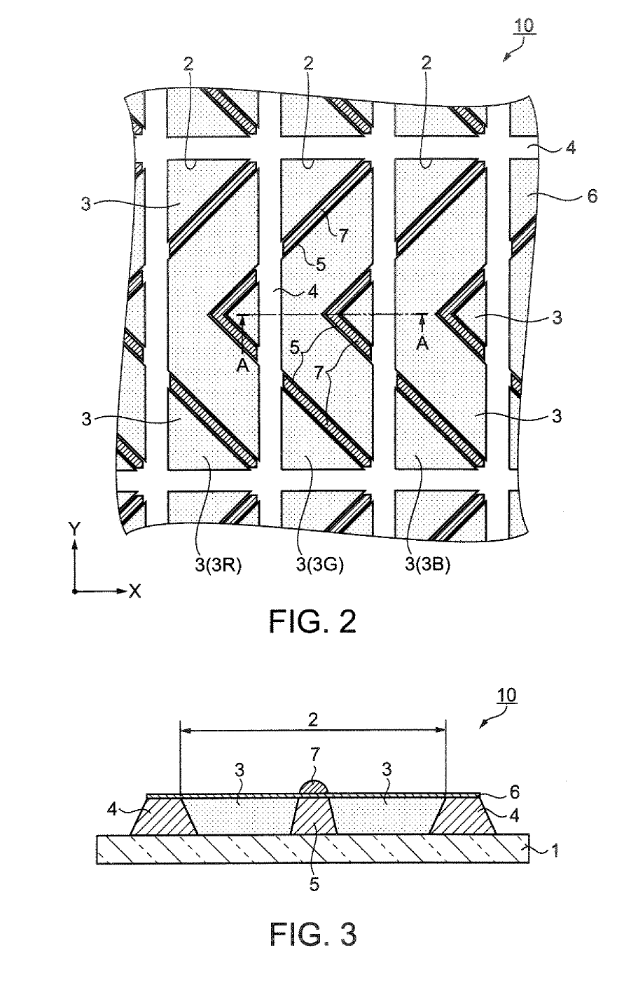

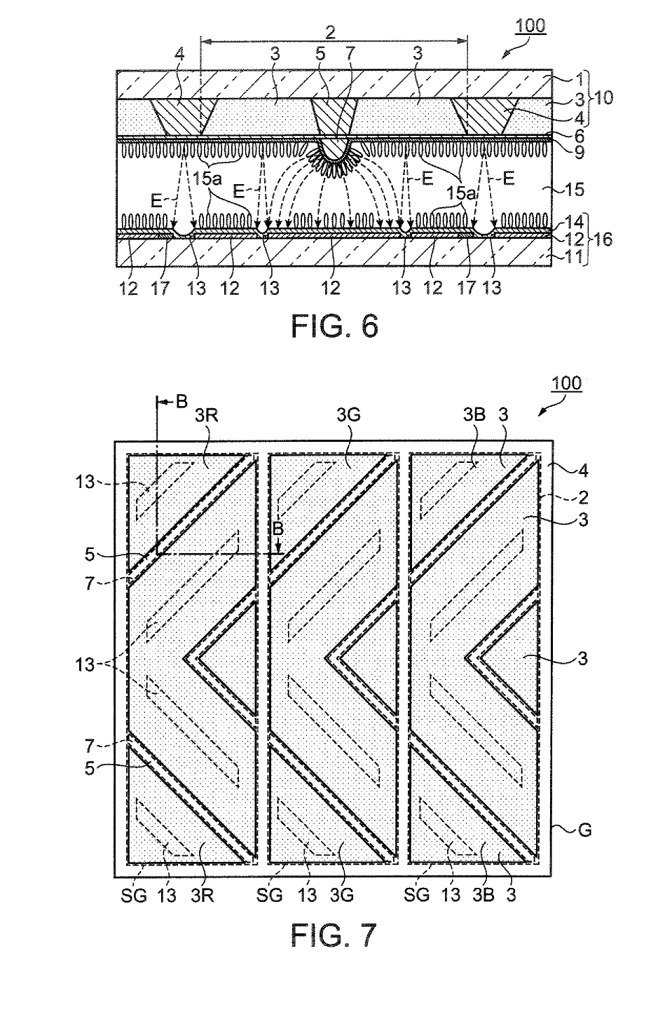

FIG. 2 is a magnified top view drawing showing color element regions. As shown in FIG. 2, second partition walls 5 subdivide the color element regions 2 that are partitioned by the first partition walls 4 into a plurality of regions. The second partition walls 5 have a bent shape, extending across the color element regions 2 that are adjacent in the x-axis direction, while the bent shape are arranged repeatedly in the y-axis direction. The second partition walls 5 are bent at an angle of approximately 90 degrees, the bent portion being located approximately in the center of each of the color element regions 2. Here, the width of the second partition walls 5 are approximately between 5 to 10 μm inclusive, and are formed with, similar to the first partition walls 4, photosensitive resin, etc. The second partition walls 5 are arranged corresponding to the direction in which projections 7 extend, which are formed for orientation control on a transparent electrode 6 that covers the first partition walls 4, the second partition walls 5, and the color elements 3. The alignment of the projections 7 for orientation control is set considering the angle of absorption or the polarizing axis of a polarizing plate equipped on a later-described liquid crystal display device 100 (refer to FIGS. 6 and 7). The shapes of the projections 7 and the corresponding second partition walls 5 are not limited to the above, as long as they are arranged so as to section the color element regions 2 into the plurality of regions, in accordance with the size or aspect ratio of the color element regions 2.

The color elements 3 are formed by discharging and thereafter drying three types (three colors) of functional fluids containing different color element forming materials, each kind per one color element region 2 that is divided into the plurality of regions. Known materials are used for such functional fluids. Examples of color element forming materials include inorganic or organic pigments, and examples of functional fluids include resins such as acrylic and polyurethane that are colored by the pigments.

FIG. 3 is a schematic sectional drawing of the color filter substrate, cut along a section A-A line shown in FIG. 2. As shown in FIG. 3, the color elements 3 are formed to have a thickness of 1.5 to 2.0 μm approximately, having about the same height as that of the first partition walls 4 and the second partition walls 5. Therefore, the transparent electrode 6 that covers the first partition walls 4, the second partition walls 5, and the color elements 3, is flat across the color element regions 2. The projections 7 are arranged on a part in the transparent electrode 6 where the part covers the second partition walls 5. The projections 7 are formed with photosensitive resin such as acrylics, having approximately the same width as the second partition walls 5, approximately ranging from 5 to 10 μm, and the height approximately ranging from 0.5 to 1 μm.

The transparent electrode 6 is composed with conductive materials such as indium tin oxide (ITO) and indium zinc oxide (IZO), and is deposited to have an appropriate electric resistance and transparency. The thickness thereof is approximately 0.1 μm.

On such color filter substrate 10, the orientation film for vertical orientation is deposited so as to cover the projections 7, and the color filter substrate 10 is used for the MVA mode liquid crystal display device 100 (refer to FIG. 6) described later

Manufacturing Method of Color Filter

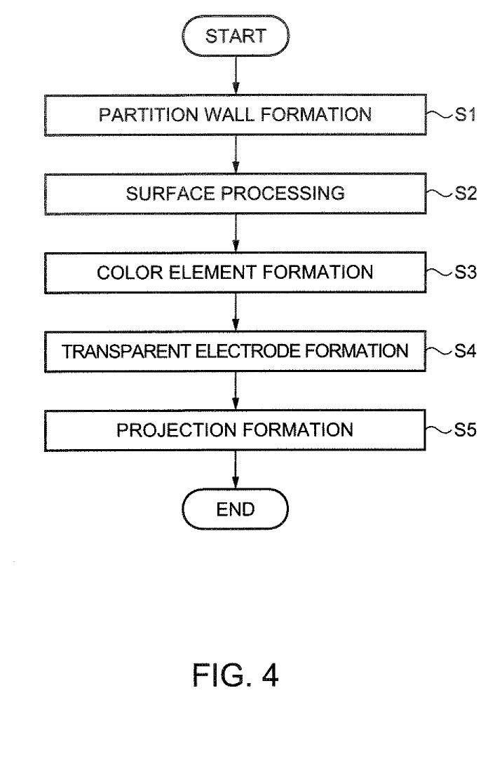

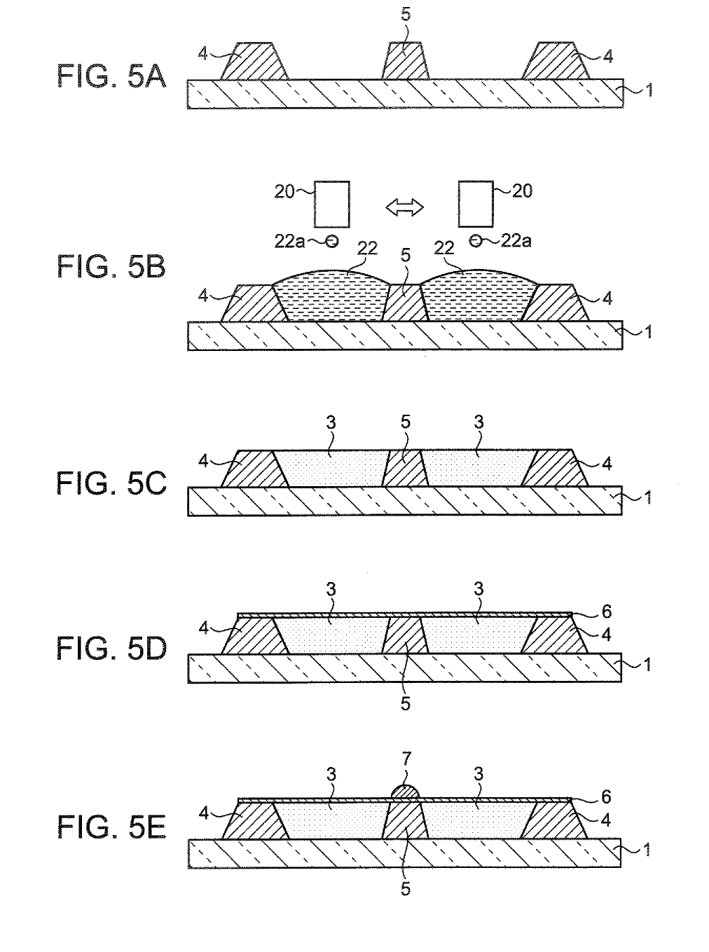

A method for manufacturing the color filter substrate according to the first embodiment will now be described with reference to FIG. 4 and FIGS. 5A to 5E. FIG. 4 is a flow chart showing the method for manufacturing the color filter substrate according to the first embodiment, and FIGS. 5A to 5E are schematic sectional drawings showing the method for manufacturing the color filter substrate.

As shown in FIG. 4, the method for manufacturing the color filter substrate 10 according to the first embodiment includes a partition wall forming process (step S1) for forming the first partition walls 4 and the second partition walls 5 on the glass substrate 1; and a surface treatment process (step S2) for providing liquid repellency to surfaces including at least vertices of the first partition walls 4 and the second partition walls 5. The method further includes a color element forming process (step S3) for forming the color elements 3 having a plurality of (three) variations, on the plurality of color element regions 2 that are divided by the first partition walls 4; and an electrode forming process (step S4) for forming the transparent electrode 6. Still further, the method includes a process for forming projections on the transparent electrode 6 (step S5).

Step S1 shown in FIG. 4 is the partition wall forming process. In step S1, as shown in FIG. 5A, the first partition walls 4 are formed so that the plurality of color element regions 2 are partitioned thereby, and at the same time, the second partition walls 5 are formed so as to divide each of the plurality of color element regions 2 into the plurality of regions. Here, the second partition walls 5 are arranged in the direction in which the projections 7 for the later-described orientation control are extended. In the method for forming such first partition walls 4 and second partition walls 5, a material having light-shielding materials such as black pigments and a material such as photosensitive phenol resin mixed together is coated on the glass substrate 1 and dried, using methods such as spin coating or roll coating. Thereafter, the photolithography may be adopted, in order to carry out exposure and development using a photomask that corresponds to the shapes of the first partition walls 4 and the second partition walls 5. The height (film thickness) of the first partition walls 4 and the second partition walls 5 ranges approximately from 1.5 to 2.0 μm, having a light-shielding property. The first partition walls 4 and the second partition walls 5 are not limited to have a single layer structure, and may also have a double layer structure, having the lower layer composed with metallic materials such as Cr, Al, and Ni that have the light-shielding properties, and the upper layer composed with organic material laminated thereon. This allows prevention of the light leak, the lower layer composed with metallic material assuring the light shielding. Thereafter, the method proceeds to step S2.

Step S2 shown in FIG. 4 is the surface treatment process. In step S2, the treatment is carried out so that the liquid repellency is provided on the surfaces of the first partition walls 4 and the second partition walls 5 including the organic material. The treatment method includes a plasma treatment having fluoride gas as a treatment gas. This allows a selective liquid repellency treatment on the surface of the organic material. Moreover, another plasma treatment having O₂ gas as a treatment gas may also be combined therewith. This allows a selective lyophilic treatment on the surface of the glass substrate 1 composed with inorganic material, causing the functional fluid discharged in later process to spread throughout the color element regions 2. That is to say, it is possible to pervade the functional fluid throughout the color element regions 2, without irregularity. In the case where the first partition walls 4 and the second partition walls 5 are composed with liquid repellent material, it is not always necessary to carry out the provision of liquid repellency. Thereafter, the method proceeds to step S3.

Step S3 shown in FIG. 4 is the color element forming process. In step S3, color elements 3 are formed by discharging functional fluids 22 containing color element forming materials to the color element regions 2, and drying them Moreover, the functional fluids 22 are discharged so that the film thickness of the color elements S that are formed becomes approximately the same height as that of the first partition walls 4 and the second partition walls 5. The discharge method of such functional fluids 22 includes a droplet discharge method, as shown in FIG. 5B, in which an un-illustrated droplet discharge device is used, the droplet discharge device including: droplet discharge heads 20 having an energy generation means that can discharge the functional fluids 22 as droplets 22a from nozzles; and a moving means that enables relative movement of the droplet discharge heads 20 to the glass substrate 1, both of which facing each other. Inefficient discharge of the functional fluids 22 is suppressed, since this droplet discharge device can discharge the functional fluids 22 to pre-set locations with on-demand bases. The energy generation unit may include: a piezoelectric element (an electric-to-mechanical conversion element); an electrostatic actuator; and a heater (an electric-to-heat conversion element). Here, three types of functional fluids 22 containing three types of color element forming materials are respectively filled into different droplet discharge heads 20, thereafter being discharged onto the corresponding color element regions 2, thereby forming three-color color elements 3R, 3G, and 3B.

Lamp annealing such as light irradiation may be used as a method to dry the discharged functional fluids 22 so as to fix the color elements 3. However, it is preferable to use the reduced pressure treatment in which the glass substrate 1 onto which the functional fluids 22 are discharged is left inside a chamber and dried under a reduced pressure. This allows formation of the color elements 3 with a uniform quality, by evaporating solvents inside the functional fluids 22 without irregularity. The drying may be carried out for each of the color elements 3, every time after discharging the corresponding functional fluids 22, or, at once after discharging the three types of functional fluids 22. Thereafter, the method proceeds to step S4.

Step S4 shown in FIG. 4 is the electrode forming process. In step S4, as shown in FIG. 5D, the transparent electrode 6 is deposited so as to cover the first partition walls 4, the second partition walls 5, and the color elements 3. The deposition method include sputtering or vapor deposition, having ITO or IZO as a target. The thickness of the transparent electrode 6 is approximately 0.1 μm for obtaining an appropriate conductivity and transparency. Thereafter, the method proceeds to step S5.

Step S5 shown in FIG. 4 is a projection forming process. In step 57, as shown in FIG. 5E, the projections 7 are formed on the transparent electrode 6, so as to control the orientation direction of liquid crystals. The forming method includes photolithography, in which photosensitive acrylic resin is coated and dried so as to cover the transparent electrode 6, and exposure and development are carried out using a photomask that corresponds to the shapes of the projections 7. As described above, the projections 7 are arranged so that they extend corresponding to the second partition walls 5 that have a bent shape. It is desirable that projections 7 be formed such that a cross-section of their vertices has circular curve or campaniform incline. Forming the orientation film for vertical orientation so as to cover such projections 7 allows the liquid crystal molecules to shift inclining to the different directions during “on” state, bordered by the projections 7.

With the above method for manufacturing the color filter substrate 10, the color elements 3 with a uniform quality are formed by pervading the functional fluids 22 evenly throughout the color element regions 2, since the color element regions 2 are divided into the plurality of regions by the second partition walls 5, and the functional fluids 22 are discharged onto each of those divided regions with reduced area size. Further, orientation control of the regions divided by the second partition walls 5 is performed by the projections 7, since those projections 7 are formed on the second partition walls 5 as an extension thereof. Still further, compared to the case without the second partition walls 5, the consumption of the functional fluids 22 for forming the color elements 3 is reduced.

Liquid Crystal Display Device

A method for manufacturing a liquid crystal display device according the first embodiment will now be described with reference to FIGS. 6 and 7. FIG. 6 is a schematic sectional drawing showing the structure of a liquid crystal display device according to the first embodiment, and FIG. 7 is a magnified top view drawing showing a pixel. Specifically, FIG. 6 is a schematic sectional drawing, cut along a section B-B line shown in FIG. 7. FIG. 7 is the magnified drawing of the pixel viewed from the color filter substrate 10.

As shown in FIG. 6, the liquid crystal display device 100 according to the first embodiment includes: the above-referenced color filter substrate 10; and an element substrate 16 that serves as a counter substrate, having a transparent substrate 11 on which a plurality of pixel electrodes 12 corresponding to the color elements 3 are formed; and liquid crystals 15 sandwiched by the color filter substrate 10 and the element substrate 16, having a negative permittivity. Thin film transistor (TFT) elements 17 that serve as switching elements that provide drive potential to the pixel electrodes 12 are installed on the element substrate 16. Orientation films 9 and 14 respectively lie on the surface of the color filter substrate 10 and on the surface of the element substrate 16, with those surfaces contacting the liquid crystals 15, and with the orientation films 9 and 14 orientating molecules 15a of liquid crystals 15 in a direction approximately perpendicular to those surfaces.

Such liquid crystal display device 100 makes information such as images displayed from the color filter substrate 10 viewable, and un-illustrated polarizing plates are mounted o the surface of the color filter substrate 10 and on the backside of the element substrate 16. Further, the liquid crystal display device 100 is illuminated by un-illustrated illumination device that has a light source, such as cold-cathode tube or LED, installed on the backside of the element substrate 16.

As shown in FIGS. 6 and 7, the liquid crystal display device 100 has a plurality of sub-pixels SG for display purposes. Three sub-pixels SG, representing three colors that correspond to the color elements 3R, 3G, and 3B, constitute one pixel G. Slits 13 serving as apertures are formed on the pixel electrodes 12 that correspond to the sub-pixels SG, at locations corresponding to the plurality of regions divided by the second partition walls 5, the slits 13 opening toward the color filter substrate 10, extending in parallel to the second partition walls 5.

FIG. 6 indicates the status of the liquid crystal display device 100 when the drive voltage is not impressed. At this time, the orienting molecules 15a of the liquid crystals 15 on the projections 7 are aligned in the direction approximately vertical to the curved surface. If the drive voltage is impressed between the transparent electrode 6 on the color filter substrate 10 and the pixel electrodes 12 on the element substrate 16, oblique electric fields E are generated between the projections 7 and the pixel electrodes 12, as well as between the slits 13 and the transparent electrode 6 excluding the projections 7. The molecules 15a of the liquid crystals 15 shift, inclining perpendicular to the directions of electric fields E. Consequently, regions (domains) bordered by the projections 7 and the slits 13 are formed, where the regions in which the direction of the molecules 15a of the liquid crystals 15 align themselves differs when the drive voltage is impressed. In other words, the orientation-controlled color element regions 2, divided into plural sections by the second partition walls 5, each have different viewing angle dependencies. Hence, the liquid crystal display device 100 with wide viewing angle can be provided.

Manufacturing Method of Liquid Crystal Display Device

A method for manufacturing the liquid crystal display device 100 according to the first embodiment allows the wastage reduction of the color element forming material. This method uses the manufacturing method of the color filter substrate 10, allowing the formation of the color elements 3 with a uniform quality in the color element regions 2. Consequently, this allows manufacturing of the MVA mode liquid crystal display device 100 with reduced defects of the color elements 3 such as clear defects and color irregularity, in a high yield.

Here, known methods can be used for: forming the pixel electrodes 12 and the TFT elements 17 on the transparent substrate 11; forming wirings that electrically connect them; adhering the color filter substrate 10 and the element substrate 16 at a prescribed location using members such as adhesives; and filling the liquid crystals 15 into the space between those substrates. Hereafter, an exemplary method is described as the method for forming the orientation films 4 and 9 that vertically orient the liquid crystals 15 on the surfaces of the color filter substrate 10 and of the element substrate 16, both of which contacting the liquid crystals 15. The exemplary method includes: adjusting viscosity by adding a solution to organic compounds such as soluble polyimide, polyimile from polyamic acids, and modified polyimide that serve as materials for orientation film; and thereafter forming the orientation films 9 and 14 by the droplet discharge method, or a printing method such as offset printing.

The effects of the first embodiment are as follows.

1. The color filter substrate 10 according to the first embodiment has the second partition walls 5 that subdivide the color element regions 2 that are partitioned by the first partition walls 4, into the plurality of regions. Moreover, the second partition walls 5 are arranged in the direction in which the projections 7 for the orientation control are extended. Therefore, compared to the case without the second partition walls 5, it is easier to flatten the color elements 3 being formed, since the color elements 3 are formed per plurality of regions, each having smaller area size, since these regions are provided as a result of dividing the color element regions. Therefore, it is possible to provide the color filter substrate 10 having color elements 3 with a uniform quality in the color element regions 2. Further, materials used in forming the colored elements are consumed in a lower wastage, since the area size for forming the color elements 3 becomes smaller.

2. In the color filter substrate 10, and in the manufacturing method thereof, according to the first embodiment, three types of color elements 3R, 3G, and 3B representing three colors are formed on the plurality of color element regions 2, by discharging the functional fluids 22 containing the color element forming materials. Consequently, the color elements 3 having uniform film thickness and flatness are formed, since the functional fluids 22 are discharged and pervaded to the color elements 3 per plurality of regions, each having a smaller area size after being divided by the second partition walls 5. That is to say, defects such as clear defects and color irregularity caused by lack of pervasion of the functional fluids 22 are reduced.

3. According to the manufacturing method of the color filter substrate 10 in the first embodiment, the liquid repellency is provided to the surfaces of the first partition walls 4 and the second partition walls 5 in the surface treatment process (step S2). Thereafter, in the color element forming process (step S3), plurality of functional fluids 22 containing different color element forming materials are discharged to the plurality of color element regions 2, from the droplet discharge heads 20 as the droplets 22a, and then dried, thereby forming the color elements 3R, 3G, and 3B that have a film thickness approximately the same height as that of the first partition walls 4 and the second partition walls 5. This allows the functional fluids 22 to be placed within the color element regions 2 without wastage, since functional fluids 22 that landed on the surface of the vertices of first partition walls 4 and the second partition walls 5 are repelled by the liquid repellency treatment. Moreover, the second partition walls 5 are arranged in the direction in which the projections 7 for orientation control extend. Hence, compared to the case where the projections 7 are formed on some regions of the transparent electrode 6 that covers the color elements 3, the wastage of the color element forming material, caused by using the material for forming the color elements 3 that do not contribute to displaying, is reduced. That is to say, it is possible to manufacture the color filter substrate 10 having color elements 3R, 3G, and 3B with a uniform quality, while reducing the wastage of the color element forming material.

4. In the first embodiment, it is possible to reduce the wastage of the color element forming material, and the liquid crystal display device 100 includes the color filter substrate 10 having color elements 3 with a uniform quality in the color element regions 2. Hence, the MVA mode liquid crystal display device 100 is provided, the device having high cost-performance and high display quality with less display defects such as clear defects and color irregularity.

5. The method for manufacturing the liquid crystal display device 100 according to the first embodiment allows elimination of the wastage of the color element forming material. This method uses the manufacturing method of the color filter substrate 10, allowing the formation of the color elements 3 with a uniform quality in the color element regions 2, in order to manufacture the color filter substrate 10 that constitute the liquid crystal display device 100. Consequently, this allows manufacturing of the MVA mode liquid crystal display device 100 with reduced defects of the color elements 3 such as clear defects and color irregularity, in a high yield.

### Second Embodiment

Color Filter Substrate

A color filter substrate according to a second embodiment will now be described. As shown in FIG. 1, a color filter substrate 30 according to the second embodiment includes, similar to the color filter substrate 10 according to the first embodiment, the first partition walls 4 for partitioning the transparent glass substrate I into the plurality of color elements regions 2, and the color elements 3R, 3G, and 3SB, formed on the plurality of color element regions 2, each representing different colors. Moreover, the color elements 3 are aligned in stripes, so that the color elements of the same color are arranged linearly. Hence, in the description hereafter, the same signs and numerals as that of the first embodiment are used for the parts that are common between the first and the second embodiment.

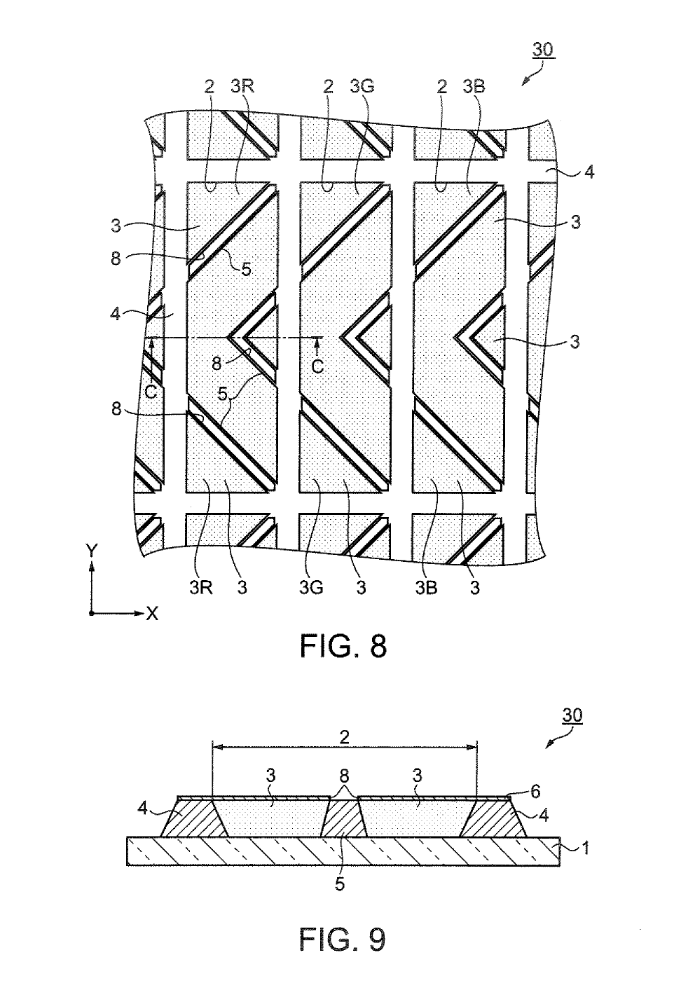

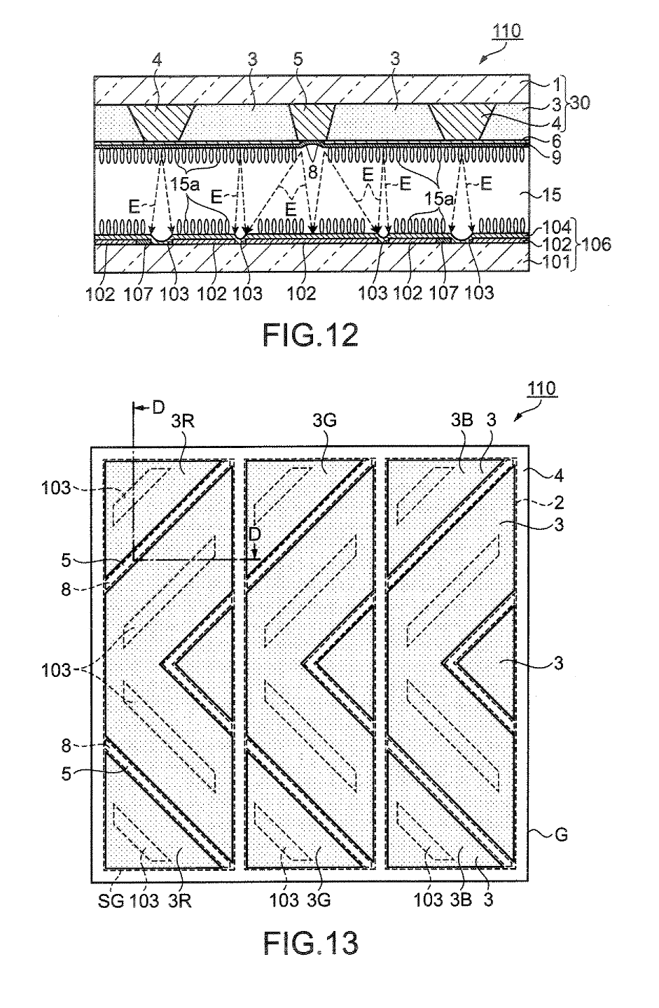

FIG. 8 is a magnified top view drawing, showing the color element regions of the color filter substrate according to the second embodiment. As shown in FIG. 8, the color element regions 2 include the second partition walls 5 that subdivide the color element regions 2 into a plurality of regions, while the color element regions 2 are partitioned by the first partition walls 4. The second partition walls 5 have a bent shape, similar to the first embodiment. Hence, the detailed description is omitted. In this case, the second partition walls 5 are arranged corresponding to the direction in which slits 8 extend, which are formed as an aperture for orientation control on the transparent electrode 6 that covers the first partition walls 4, the second partition walls 5, and the color elements 3. The alignment of the slits 8 for orientation control is set considering the angle of absorption or polarizing axis of the polarizing plate equipped on a later-described liquid crystal display device 110 (refer to FIGS. 12 and 13). The shapes of the slits 8 and the corresponding second partition walls 5 are not limited to the above, as long as they are arranged so as to section the color element regions 2 into the plurality of regions, in accordance with the size or aspect ratio of the color element regions 2.

FIG. 9 is a schematic sectional drawing of the color filter substrate, cut along a section C-C line in FIG. 8 As shown in FIG. 9, the color elements 3 are formed to have a thickness of 1.5 to 2.0 μm approximately; having about the same height as that of the first partition walls 4 and the second partition walls 5. Therefore, the transparent electrode 6 that covers the first partition walls 4, the second partition walls 5, and the color elements 3, is flat across the color element regions 2. The slits 8 are arranged on a part in the transparent electrode 6 where the part covers the second partition walls 5. The slits 8 are formed by etching the transparent electrode 6, having approximately the same width as the second partition walls 5, approximately ranging from 5 to 10 μm.

On such color filter substrate 30, the orientation film for vertical orientation is deposited so as to cover the surface of the transparent electrode 6 where the slits 8 are formed, and this color filter substrate 30 is used for the MVA mode liquid crystal display device 110 (refer to FIG. 12) described later.

Manufacturing Method of Color Filter Substrate

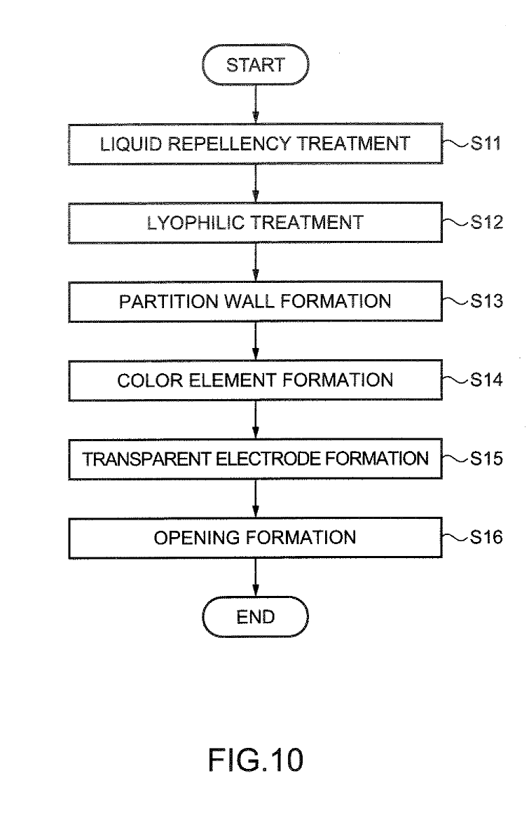

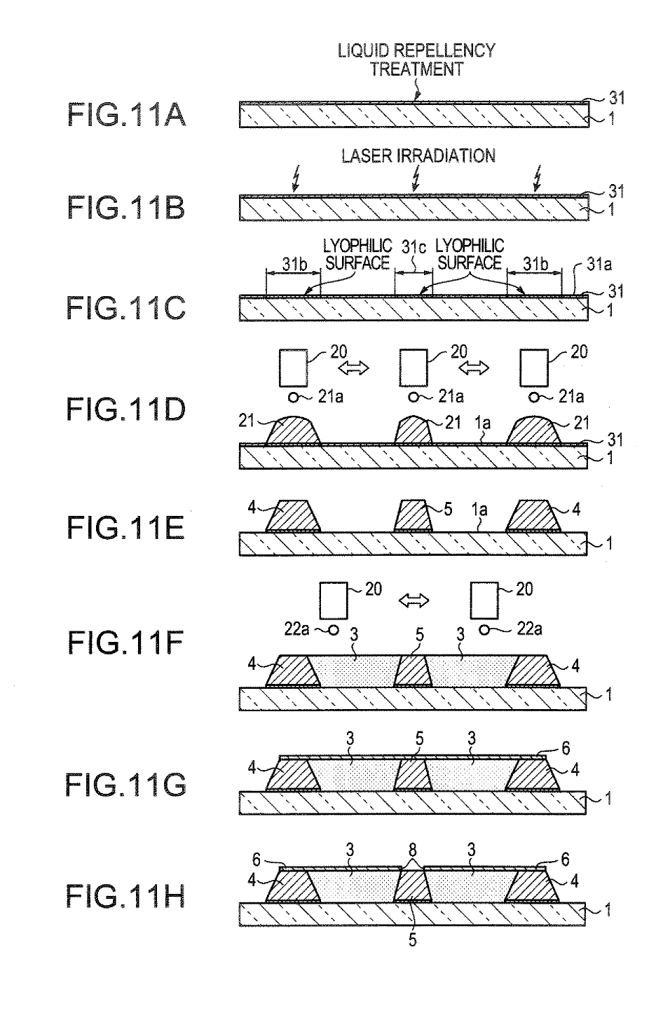

A method for manufacturing the color filter substrate according to the second embodiment will now be described with reference to FIG. 10 and FIGS. 11A to 11H. FIG. 10 is a flow chart showing the method for manufacturing the color filter substrate according to the second embodiment, and FIGS. 11A to 11H are schematic sectional drawings showing the method for manufacturing the color filter substrate.

As shown in FIG. 10, the method for manufacturing the color filter substrate 30 according to the second embodiment includes: a liquid repellency treatment process (step S11) for treating the surface of the glass substrate 1 so as to provide liquid repellency thereto; and a lyophilic treatment process (step S12) for treating the surface of the glass substrate 1 provided with liquid repellency, in order to provide lyophilic property to the surface areas that correspond to the regions for forming the first partition walls 4 and the second partition walls 5. The method further includes: the partition wall forming process (step S13) for forming the first partition walls 4 and the second partition walls 5 on the glass substrate 1; and the color element forming process (step S14) for forming the color elements 3 having the plurality of types, on the plurality of color element regions 2. The method still further includes: the electrode forming process (step S15) for forming the transparent electrode 6; and an aperture forming process (step S16) for forming the slits 8 as apertures on the transparent electrode 6.

Step S11 shown in FIG. 10 is the liquid repellency treatment process, In step S11, as shown in FIG. 11A, a thin film 31 is formed on the surface of the glass substrate 1, so as to provide liquid repellency thereon. The thin film 31 that is approximately monomolecular is formed using fuoroalkylsilane (FAS) or hexamethyldisilane (HMDS) as a liquid repellent material. More specifically, methods such as forming a self-assembled film on the surface of the glass substrate 1 can be employed.

In the method for forming the self-assembly film, the self-assembly film composed of an organic molecular film and the like is formed on the surface of the glass substrate 1. The organic molecular film has a functional group that can be bonded to the glass substrate 1; another functional group, existing on the other side as a liquid repellent group, modifying the surface property (or, controlling the surface energy); and a linear or branch carbon chain that connects these functional groups. The organic molecular film bonds with the glass substrate 1 and self-assembles, forming the molecular film such as a monolayer.

Here, the self-assembled film consists of: a bonding functional group that reacts with constituent atoms of the layer of the glass substrate I (such as undercoat layer); and the linear chain molecules not from the bonding functional group, Compounds having an extremely high orientation property, due to the interactions of linear chain molecules with each other, are oriented to form the self-assembled film. The self-assembled film is formed with a unimolecular orientation, allowing the film thickness to be extremely thin, providing uniformity to the film in molecular level. In other words, molecules of the same substance are located on the surface of the filmy thereby allowing to provide a uniform and excellent liquid repellency to the surface of the film.

By using, for instance, fluoroalkylsilanes as compounds that have the high orientation property, the compounds are oriented such that a fluoroalkyl group is positioned on the film surface, thereby forming a self-assembled film, providing an even liquid repellency on the film surface. Compounds for forming the self-assembled film include fluoroalkylsilanes (hereinafter, referred to as “FAS”) such as heptadecatluoro-1,12,2tetrahydrodecyltriethoxysilane, heptadecafluoro-1,1,2,2tetrahydrodecyltrimethoxysilane, heptadecafluoro-1,1,2,2tetrahydrodecyltrichlorosilane, tridecanfluoro-1,1,2,2tetrahydrooctyltriethoxysilane, tridecanfluoro-1,1,2,2tetrahydrooctyltrimethoxysilane, tridecanfluoro-1,1,2,2tetrahydrooctyltrichlorosilane and trifluoroprophyltrimethoxysilane. These compounds may be used independently, or, in combination of two or more variations. The adhesiveness to the glass substrate 1 and favorable liquid repellency are obtained by using FAS.

FAS is generally expressed by the structural formula Rₙ SiX₍₄₋ₙ₎. Here, “n” indicates an integer from 1 to 3, and “X” indicates a hydrolytic group such as a methoxy group, an ethoxy group and halogen atoms, Further, “R” represents the fluoroalkyl group, and has the structure of (CF₃)(CF₂)x(CH₂)_{y} (where, “x” is an integer from 0 to 10, and “y” is an integer from 0 to 4). In a case where a plurality of R or X is bonded to Si, R and X may be the same or different from each other. The hydrolytic group indicated by X forms silanol with hydrolysis, reacts with the hydroxy group at the undercoat of the glass substrate 1, and bonds with the glass substrate 1 through siloxane bond. Meanwhile, since R has a fluoric group such as CF₂ on its surface, it is reformed into a surface having a low surface energy, causing an underlying surface of the glass substrate 1 not to get wet.

The self-assembled film composed of an organic molecule film is formed on the glass substrate 1 by: placing the raw compound described above as well as the glass substrate 1 in the same airtight container; and leaving them for about 2 to 3 days at room temperature. Alternatively, by maintaining the whole airtight container at a temperature of 100 degrees C. the self-assembled film is formed on the glass substrate 1 after about three hours. The above is the method of forming the self-assembled film in a vapor phase, while it may be formed in a liquid phase. For instance, the self assembled film is formed on the glass substrate 1 by dipping it into the solution containing the raw compound, then washing and drying it. It is preferable to perform a pre-treatment on the surface of the glass substrate 1 prior to the self-assembled film formation, by irradiating the surface thereof with UV light, or by washing the surface with a solvent. Thereafter, the method proceeds to step S12.

Step S12 shown in FIG. 10 is the lyophilic treatment process. In step S12, as shown in FIG. 11B, a lyophilic property is provided by irradiating a light onto the liquid repellent surface 31a. The light irradiation breaks Siloxane bonds and forms hydroxyl bonds, providing the lyophilic property to the surface 31a. In this case, the regions of irradiation includes, as shown in FIG. 11C, regions 31b for forming the first partition walls 4 and regions 31c for forming the second partition walls 5.

A laser beam having a range of wavelengths in which the heat is produced is preferable as the irradiation light; the ones having a wavelength range of 0.7 to 10 μm such as infrared are preferable. Such laser light source includes, for instance, lasers such as Nd:YAG-laser (1.064 μm) and CO₂ laser (10.6 μm). The lyophilic treatment is carried out by irradiating the Laser beam with a laser device, so as to write the regions 31b and 31c on the glass substrate 1 that is placed on a table of the laser device, the laser device including a laser light source and the table which can be moved at least in the x and y-axis directions.

As a method of lyophilic treatment of the thin film 31 composed with FAS and the like, an ultraviolet (UV) irradiation may also be employed, covering the regions except regions 31b and 31c that are to be processed with lyophilic treatment. Thereafter, the method proceeds to step S13.

Step S13 shown in FIG. 10 is the partition wall forming process. In step S13, as shown in FIG. 11D, the first partition walls 4 and the second partition walls 5 are formed by discharging functional fluid 21 using the droplet discharge heads 20 which can discharge a liquid substance from the nozzles in droplets, the functional fluid 21 containing the partition wall forming material as the liquid substance.

More specifically, the droplet discharge heads 20 are positioned so that they sequentially face the regions 31b for forming the first partition walls 4, and thereafter the regions 31c for forming the second partition walls 5. The functional fluid 21 is discharged by the droplet discharge heads 20 as droplets 21a, so that it lands and spreads on the regions 31b and 31c. Thereafter, the droplets 21a are dried. Hence, the first partition walls 4 and second partition walls 5 are deposited and formed by repeating the above steps. The height of the first partition walls 4 and the second partition walls 5 is approximately 1.5 μm. Solution including resins such as phenolics can be used for the functional fluid 21 as the partition wall forming material. Thereafter, the method proceeds to step S14.

Step S14 shown in FIG. 10 is the color element forming process. In step S14, as shown in FIG. 11E, a step for removing the thin film 31 is carried out, where the think film 31 remains on the glass substrate I on which the first partition walls 4 and the second partition walls 5 are formed. The thin film 31 is a monolayer composed with FAS and the like, and can be removed by sublimation, heating the glass substrate 1 at approximately 300 degrees C. Moreover, a surface la of the glass substrate 1 after the removal can be processed with lyophilic treatment. As the method other than heating, methods such as UV irradiation or O₂ plasma treatment may also be employed.

Thereafter, as shown in FIG. 11F, the functional fluids 22 containing the color element forming material are discharged, from the droplet discharge heads 20 as the droplets 22a, to the color element regions 2, per plurality of regions divided by the second partition walls 5, and thereafter dried, thereby forming the color elements 3. Naturally, three kinds of functional fluids 22 containing different color element forming materials are sequentially filled into the droplet discharge head 20 and discharged therefrom, where the three kinds of functional fluids 22 correspond to the color element regions 2 in which the color elements 3R, 3G, and 3B representing three colors are to be formed. Alternatively, the plurality of droplet discharge heads 20 may be prepared so that the different functional fluids 22 containing different color element forming materials are filled thereto and discharged therefrom.

In those cases, the discharge frequency adjustment of the droplets 22a is performed per plurality of regions, so that the film thickness of the color elements 3 after drying becomes approximately the same as the height of the first partition walls 4 and the second partition walls 5 (approximately 1.5 μm). This allows the functional fluids 22 to pervade throughout the color element regions 2, thereby allowing the color elements 3R, 3G, and 3B to be formed with uniform quality. The detailed description of the drying method is omitted, since it is similar to step S3 in the manufacturing method of the color filter substrate 10 according to the embodiment 1. Thereafter, the method proceeds to step S15.

Step S15 shown in FIG. 10 is the electrode forming process. In step S15, as shown in FIG. 11G, the transparent electrode 6 composed with ITO or IZO is deposited so as to cover the first partition walls 4, the second partition walls 5, and the color elements 3. The description of the deposition method is omitted, since it is similar to that of the first embodiment. Thereafter, the method proceeds to step S16.

Step S16 shown in FIG. 10 is a process for forming the slits 8 as apertures. In step S16, as shown in FIG. 11H, the slits 8 are formed on a part in the transparent electrode 6 where the part covers the second partition walls 5. The forming method includes photolithography, in which: photo resist is coated and dried so as to cover the transparent electrode 6; and exposure, development, and etching are carried out, using a photomask that has a shape of the apertures of the slits 8 corresponding to the second partition walls 5 that have a bent shape. The width of the slits 8 formed is approximately the same as that of the second partition walls 5, approximately ranging from 5 to 10 μm. As another method for forming such a fine slits 8, the method described before in the lyophilic treatment process (step S12) may also be employed, in which the unnecessary portions are removed by irradiating the laser beam to the transparent electrode 6. Forming the orientation film for vertical orientation so as to cover the slits 8 allows the liquid crystal molecules to shift inclining to the different directions during “on” state, bordered by the projections 8.

With the above method for manufacturing the color filter substrate 30, color elements 3 with a uniform quality are formed by pervading the functional fluids 22 evenly throughout the color element regions 2, since the color element regions 2 are divided into the plurality of regions by the second partition walls 5, and the functional fluids 22 are discharged onto each of those divided regions with reduced area size. Further, orientation control of the regions divided by the second partition walls 5 is performed by the slits 8, since the second partition walls 5 are arranged in the direction in which the slits 8 extend. Still further, compared to the case without the second partition walls 5, the consumption of the functional fluids 22 for forming the color elements 3 is reduced.

Moreover, compared to the manufacturing method of the color filter substrate 10 according to the first embodiment, the first partition walls 4 and the second partition walls 5 are formed with the droplet discharge method (inkjet method), without using photolithography. Thus, manufacturing process such as exposure and development can be simplified.

Liquid Crystal Display Device

A method for manufacturing a liquid crystal display device according the second embodiment will now be described with reference to FIGS. 12 and 13. FIG. 12 is a schematic sectional drawing showing the structure of the liquid crystal display device according to the second embodiment, and FIG. 13 is a magnified drawing showing a pixel. Specifically, FIG. 12 is a schematic sectional drawing, cut along a section D-D line shown in FIG. 13. FIG. 13 is the magnified drawing of the pixel viewed from the color filter substrate 30.

As shown in FIG. 12, the liquid crystal display device 110 according to the second embodiment includes: the above-referenced color filter substrate 30; and an element substrate 106 that serves as the counter substrate, having a transparent substrate 101 on which a plurality of pixel electrodes 102 corresponding to the color elements 3 are formed; and liquid crystals 15 sandwiched by the color filter substrate 30 and the element substrate 106, having a negative permittivity. Thin film transistor (TFT) elements 107 that serve as the switching elements that provide drive potential to the pixel electrodes 102 are installed on the element substrate 106. Orientation films 9 and 104 respectively lie on the surface of the color filter substrate 30 and on the surface of the element substrate 106, with those surfaces contacting the liquid crystals 15, and with the orientation films 9 and 14 orientating molecules 15a of liquid crystals 15 in the direction approximately vertical to those surfaces. That is to say, in the liquid crystal display device 110, the projections 7 for orientation control in the liquid crystal display device 100 of the first embodiment is replaced with the slits 8. Therefore, a detailed description of the common structure is omitted, and an description is made mainly for different structures.

As shown in FIGS. 12 and 13, the liquid crystal display device 110 has the plurality of sub-pixels SG for display purposes. Three sub-pixels SG, representing three colors that correspond to the color elements 3R, 3G, and 3B, constitutes one pixel G. Slits 103 serving as apertures are formed on the pixel electrodes 102 that correspond to the sub-pixels SG, at locations corresponding to the plurality of regions divided by the second partition walls 5, the slits 103 opening toward the color filter substrate 30, extending in parallel to the second partition walls 5.

FIG. 12 indicates the status of the liquid crystal display device 110 when the drive voltage is not impressed. At this time, the molecules 15a of the liquid crystals 15 orient in the direction approximately vertical to the orientation films 9 and 104 that cover the surfaces of the color filter substrate 30 and the element substrate 106. If the drive voltage is impressed between the transparent electrode 6 on the color filter substrate 30 and the pixel electrodes 12 on the element substrate 106, oblique electric fields E are generated between the slits 8 and the pixel electrodes 12, as well as between the slits 103 and the transparent electrode 6 excluding the slits 8. The molecules 15a of the liquid crystals 15 shift to be perpendicular to the directions of electric fields E. Consequently, the regions (domains) bordered by the slits 8 and 103 are formed, the regions in which the direction of the molecules 15a of the liquid crystals 15 align themselves differs when the drive voltage is impressed. In other words, the orientation-controlled color element regions 2, divided into plural sections by the second partition walls 5, each have different viewing angle dependencies. Hence, the liquid crystal display device 110 with wide viewing angle can be provided.

Manufacturing Method of Liquid Crystal Display Device

A method for manufacturing the liquid crystal display device 110 according to the second embodiment allows elimination of the wastage of the color element forming material. This method uses the manufacturing method of the color filter substrate 30 having simplified manufacturing process, allowing the formation of the color elements 3 with a uniform quality in the color element regions 2. Consequently, this allows manufacturing of the MVA mode liquid crystal display device 110 in high productivity with reduced defects of the color elements 3 such as clear defects and color irregularity, in a high yield.

The second embodiment further includes the following effects, in addition to the effects similar to the effects 1 and 2 of the first embodiment described above.

1. According to the manufacturing method of the color filter substrate 30 in the second embodiment, the first partition walls 4 and the second partition walls 5 are formed on the glass substrate 1, by repeating the steps of discharging and drying the functional fluid 21 in the partition wall forming process (step S13), where the discharging is carried out so that the functional fluid 21 containing the partition wall forming material is discharged to the regions 31b and 31c on the lyophilic thin film 31, from the droplet discharge heads 20 as the droplets 21a. Thereafter, in the color element forming process (step S14), the plurality of functional fluids 22 containing different color element forming materials are discharged to the plurality of color element regions 2, from the droplet discharge heads 20 as the droplets 22a, and then dried, thereby forming the color elements 3R, 3G, and 3B that have a film thickness approximately the same height as that of the first partition walls 4 and the second partition walls 5. Consequently, in contrast to the case of forming the first partition walls 4 and the second partition walls 5 by photolithography, the photomask for exposure is not required, and the manufacturing steps such as exposure and development are simplified. That is to say, it is possible to manufacture the color filter substrate 30 having color elements 3R, 3G, and 3B with a uniform quality, in high production efficiency, while cutting out the wastage of the color element forming material.

2. In the second embodiment, it is possible to reduce the wastage of the color element forming material, and the liquid crystal display device 110 includes the color filter substrate 30 having color elements 3 with a uniform quality in the color element regions 2. Hence, the MVA mode liquid crystal display device 110 is provided, the device having high cost-performance and high display quality with less display defects such as clear defects and color irregularity.

3. The method for manufacturing the liquid crystal display device 110 according to the second embodiment has higher production efficiency, and allows reduction of the wastage of the color element forming material. This method uses the manufacturing method of the color filter substrate 30, allowing the formation of the color elements 3 with a uniform quality in the color element regions 2, in order to manufacture the color filter substrate 30 that constitute the liquid crystal display device 110. Consequently, this allows manufacturing of the MVA mode liquid crystal display device 110 in high production efficiency, with reduced defects of the color elements 3 such as clear defects and color irregularity, in a high yield.

### Third Embodiment

Electronic Apparatus

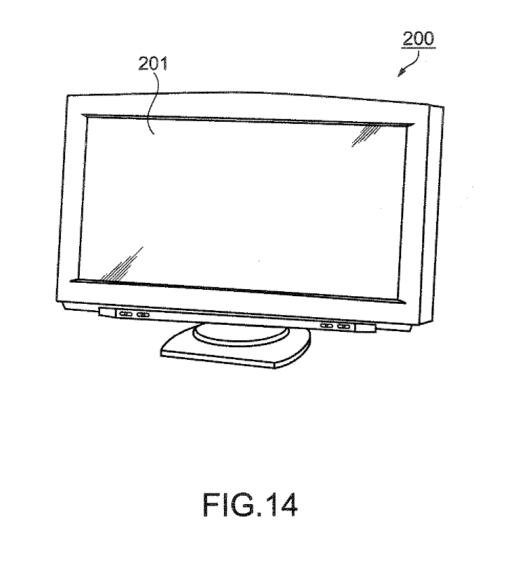

A large-sized liquid crystal television as the electronic apparatus according to the third embodiment will now be described. FIG. 14 is a schematic oblique drawing showing a large-sized liquid crystal television. As shown in FIG. 14, a display unit 201 of a large-sized liquid crystal television 200 is mounted with either the liquid crystal display device 100 according to the first embodiment, or the liquid crystal display device 110 according to the second embodiment, both having a wide viewing angle.

The effects of the third embodiment are as follows.

The liquid crystal display devices 100 and 110 are manufactured in a high yield, with reduced defects such as clear defects and color irregularity. Hence, the large-sized liquid crystal television 200 is provided, having excellent display quality and high cost-performance.

Modifications other than the above-described embodiments are as follows.

First Modification

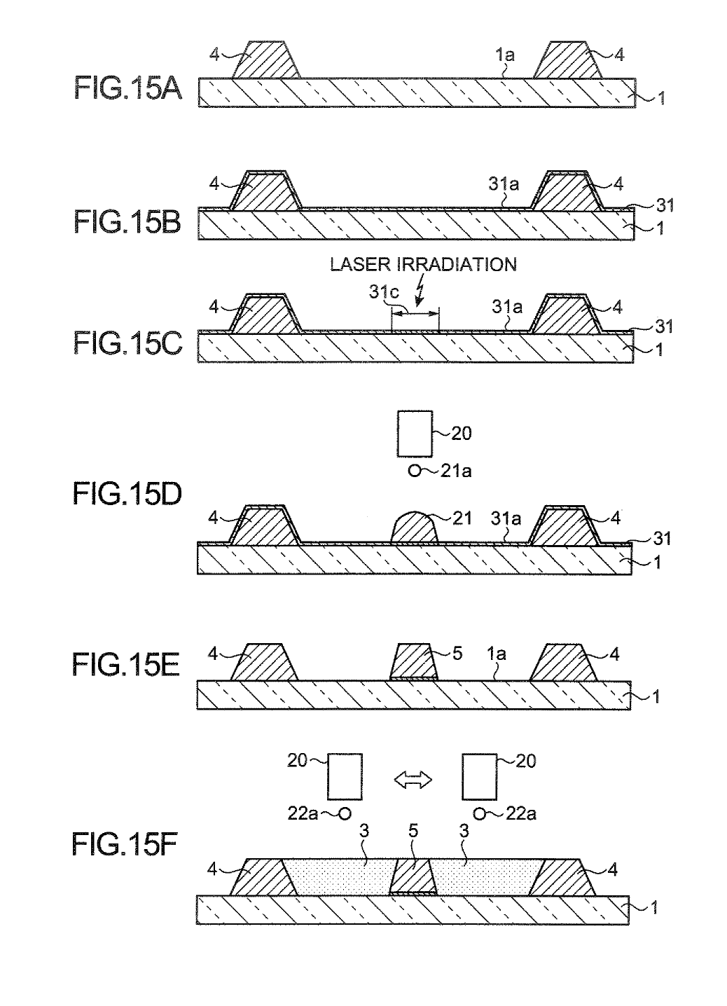

In the manufacturing method of the color filter substrate 30 of the second embodiment, the method for forming the first partition walls 4 is not limited to the droplet discharge method (inkjet method). FIGS. 15A to 15F are schematic sectional drawings showing the method for manufacturing the color filter according to modifications. First, as shown in FIG. 15A, the first partition walls 4 are formed on the glass substrate 1. Here, the first partition walls 4 are formed by coating the photosensitive resin on the surface of the glass substrate 1 at a film thickness of 1.5 to 2.0 μm approximately, followed by exposure and development thereof. The photosensitive resin may desirably have light-shielding properties, containing black pigments and the like. Thereafter, as shown in FIG. 15B, the thin film 31 is formed so as to provide liquid repellency to the surface of the glass substrate 1 on which the first partition walls 4 are formed. As shown in FIG. 15C, the laser beam is then irradiated on the regions 31c of the liquid repellent surface 31a, so as to provide the lyophilic property to the regions 31c where the second partition walls 5 are to be formed. Subsequently, as shown in FIG. 15D, the first partition walls 5 are formed by discharging the functional fluids 21 containing the partition wall forming material, from the droplet discharge heads 20 as the droplets 21a. The liquid repellent thin film 31 is then removed, as shown in FIG. 15E, with methods such as heating. Thereafter, as shown in FIG. 15F, the functional fluids 22 containing the color element forming materials are discharged, from the droplet discharge heads 20 as the droplets 22a, to the color element regions 2 that are divided by the first partition walls 4 and the second partition walls 5. Further, the transparent electrode 6 is deposited so as to cover the first partition walls 4, the second partition walls 5, and the color elements 3, in a similar manner as that of the second embodiment, and the slits 8 are formed by etching the transparent electrode 6 where it corresponds to the second partition walls 5. This way, the color element regions 2 that correspond to the sub-pixels SG are formed in a consistent manner. By forming or manufacturing the liquid crystal display device 110 using the color filter substrate 30 manufactured in the above-described manner, clearer image display is attained, preventing light leak from the gap between the sub-pixels SG, since the first partition walls 4 formed have light-shielding properties.

Second Modification

In the color filter substrate 10 according to the first embodiment as well as in the color filter substrate 30 according to the second embodiment, the width of the second partition walls 5 is not necessarily the same as that of the projections 7, nor is it necessarily the same as that of the slits 8. For instance, if the width of the second partition walls 5 is made wider than that of the projections 7 or the slits 8, in consideration of the precision in forming them, it is possible to avoid the protrusion of the projections 7 or the slits 8 from the regions where the second partition walls 5 are formed.

Third Modification

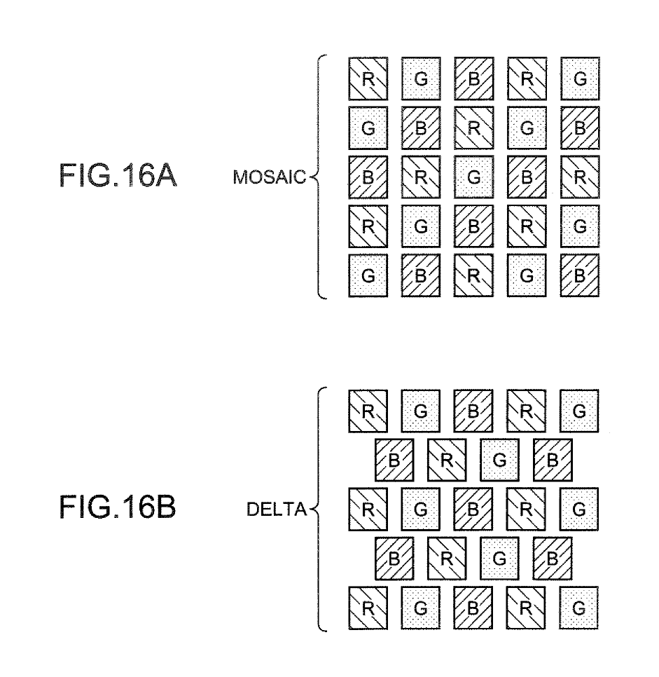

The structure of the color elements 3 in the color filter substrate 10 or in the color filter substrate 30 is not limited to what is described in the first or second embodiments. For example, the color elements 3R, 3G, and 3B may be arranged in different order, while, in the above embodiments, they are aligned in stripes. FIGS. 16A and 16B are top view drawings showing an arrangement of color elements according to modifications. Mosaic alignment and delta alignment may also be the structure in which the invention is applied, where, in the mosaic alignment, the color elements of the same color are arranged in oblique direction, and in the delta alignment, the color elements in different colors are arranged in the vertex of a triangle. Further, the color elements 3 are not limited to have three colors, and may have four colors, with the extra color improving the color reproduction.

Forth Modification

In the liquid crystal display device 100 according to the first embodiment, or in the liquid crystal display device 110 according to the second embodiment, the switching elements connected to the pixel electrodes 12 or 102 are not limited to the TFT elements 17 or 107. Thin film diode (TFT), for instance, may also be utilized. Moreover, not limited to the transmissive display having the illumination device, the color filter substrate 10 or 30 according to the above-referenced embodiments may be applied to a semi-transmissive reflective display, having reflective layers on a part of the pixel electrodes 12 or 102 of the element substrate 16 or 106.

Fifth Modification

The electronic apparatuses mounted with either the liquid crystal display device 100 or 110 of the first or second embodiment, are not limited to the large-sized liquid crystal television 200. Other examples of the electronic apparatuses that are suitably used as an image display unit include: mobile equipments such as personal digital assistants (PDA), mobile terminals, personal computer, word processor, digital still camera, in-vehicle monitor, direct-view monitor type video tape digital video recorder, car navigation device, electric notebook, workstation, video phone, point-of-sale terminal, and the like.

The entire disclosure of Japanese Patent Application No. 2005-364471, filed Dec. 19, 2005 is expressly incorporated by reference herein.

What is claimed is:

1. A color filter substrate comprising:
a first partition wall for partitioning a substrate into a plurality of color element regions;
a second partition wall for dividing each of the plurality of color element regions into a plurality of regions;
color elements having a plurality of types, being formed on the plurality of color element regions;
a transparent electrode covering the first partition wall, the second partition wall, and the color element; and
a projection or an aperture formed on the transparent electrode;
wherein the second partition wall is arranged in the direction in which the projection or the aperture is extended.

2. The color filter substrate according to claim 1, wherein the color elements are formed by discharging a functional fluid containing a color element forming material, to the color element regions.

3. The color filter substrate according to claim 1, wherein the color elements have an approximately the same film thickness as that of the first partition wall and the second partition wall.

4. A liquid crystal display device comprising:
the color filter substrate according claim 1;
a counter substrate having a plurality of pixel electrodes corresponding to the plurality of color element regions on the color filter substrate; and
liquid crystals sandwiched by the color filter substrate and the counter substrate;
wherein an orientation film is provided to surfaces which contact the liquid crystals, the orientation film orienting molecules of liquid crystals in a direction approximately vertical to the surfaces of the color filter substrate and of the counter substrate.

5. The liquid crystal display device according to claim 4, wherein an aperture is provided on the pixel electrodes, at locations corresponding to the plurality of regions which are divided by the second partition wall, the aperture opening toward the color filter substrate, extending in parallel to the second partition wall.

6. An electronic apparatus having the liquid crystal display device according to claim 4 mounted thereon.

7. A method for manufacturing a color filter substrate, comprising:
a partition wall forming process for forming a first partition wall and a second partition wall on a substrate, a plurality of color element regions partitioned by the first partition wall, and the second partition wall dividing each of the plurality of color element regions into a plurality of regions:
a color element forming process for forming color elements having a plurality of variations, by discharging a plurality of functional fluids containing different color element forming materials, to the color element regions;
an electrode forming process for forming a transparent electrode covering the first partition wall, the second partition wall, and the color element; and
a process for forming a projection or an aperture formed on the transparent electrode;
wherein, in the partition wall forming process, the second partition wall is arranged in the direction in which the projection or the aperture is extended.

8. The method for manufacturing the color filter substrate according to claim 7, wherein, in the color element forming process, the functional fluid is discharged so that the color elements have an approximately the same film thickness as that of the first partition wall and the second partition wall.

9. The method for manufacturing the color filter substrate according to claim 7, further comprising a surface treatment process for providing liquid repellency to surfaces including at least vertices of the first partition wall and the second partition wall.

10. The method for manufacturing the color filter substrate according to claim 7, further comprising:
a liquid repellency treatment process for providing liquid repellency to a surface of the substrate; and
a lyophilic treatment process for providing a lyophilic property to the liquid repellent surface of the substrate corresponding to the regions for forming the first partition wall and the second partition wall;
wherein, in the partition wall forming process, the first partition wall and the second partition wall are formed by discharging a functional fluid containing a partition wall forming material to the lyophilic surface of the substrate.

11. The method for manufacturing the color filter substrate according to claim 7, further comprising:
a liquid repellency treatment process for providing liquid repellency to a surface of the substrate on which the first partition wall is formed; and
a lyophilic treatment process for providing the lyophilic property to a liquid repellent surface of the substrate corresponding to the region for forming the second partition wall;
wherein, when forming the second partition wall, the second partition wall is formed by discharging a functional fluid containing a partition wall forming material to the lyophilic surface of the substrate.

12. The method for manufacturing the color filter substrate according to claim 10, wherein, in the lyophilic treatment process, the lyophilic property is provided to a liquid repellent surface including at least the region corresponding to where the second partition wall is to be formed, by irradiating a light thereon.

13. The method for manufacturing the color filter substrate according to claim 10, wherein:
in the liquid repellency treatment process, a thin film having liquid repellency is deposited on the surface of the substrate; and
in the color element forming process, the thin film remaining at least on the color element regions is removed.

14. A method for manufacturing a liquid crystal display device, comprising:
forming a color filter substrate, using the method for manufacturing the color filter substrate according to claim 7;
wherein the liquid crystal display device includes:
the color filter substrate having color elements having a plurality of types;
a counter substrate having a plurality of pixel electrodes corresponding to the color elements provided with a plurality of types;
liquid crystals sandwiched by the color filter substrate and the counter substrate; and
an orientation film, provided to surfaces which contact the liquid crystals, orienting molecules of liquid crystals in a direction approximately vertical to the surfaces of the color filter substrate and of the counter substrate.
